(19) United States
(12) Patent Application Publication
(10) Pub. No.: US 2008/0279393 A1
(43) Pub. Date: Nov. 13, 2008

(54) Noise Eliminating Circuit

(75) Inventors: Yasuji Saito, Gunma (JP); Yutaka y Hirakoso, Ibaraki (JP); Masaaki Taira, Hyogo (JP)

Correspondence Address: SoCAL IP LAW GROUP LLP, 310 N. WESTLAKE BLVD. STE 120, WESTLAKE VILLAGE, CA, 91362, US

(73) Assignee: Sanyo Electric Co., Ltd., Osaka (JP)

(21) Appl. No.: 10/599,458

(22) PCT Filed: Feb. 23, 2005
(86) PCT No.: PCT/JP2005/002897

§ 371 Date: Jul. 25, 2008

(30) Foreign Application Priority Data
Mar. 30, 2004 (JP) 2004-099358

(51) Int. Cl. H04B 15/00

(52) U.S. Cl. 381/94.4

(57) ABSTRACT

A noise eliminating circuit is disclosed which comprises a noise elimination processing unit that interpolates a generation period of pulse noise overlapped with a received signal depending on a first detection signal acquired by level detection of an intermediate frequency signal of the received signal, the first detection signal indicating the generation of the pulse noise, wherein the noise eliminating circuit comprises: a predicting unit that predicts a value of the intermediate frequency signal at a predetermined clock time based on an intermediate frequency signal generated a predetermined time earlier than the intermediate frequency signal; a detecting unit that compares a difference between the value of the predicted intermediate frequency signal and the value of the generated intermediate frequency signal, at the predetermined clock time, with a predetermined threshold, to output a second detection signal indicating the generation of the pulse noise; and a noise elimination controlling unit that selectively outputs the first detection signal and the second detection signal as a signal for interpolating the generation period of the pulse noise to the noise elimination processing unit depending on electric field intensity signal acquired based on the intermediate frequency signal.

### CROSS-REFERENCE TO RELATED APPLICATION

This application claims the benefit of priority to International Patent Application PCT/JP2005/002897, filed Feb. 23, 2005, of which full contents are incorporated herein by reference.

### BACKGROUND OF THE INVENTION

1. Technical Field

The present invention relates to a noise eliminating circuit.

2. Description of the Related Art

When receiving radio broadcasting, for example, when receiving AM broadcasting with an on-vehicle AM receiver, a received signal may be overlapped with noise in a form of pulse (hereinafter, pulse noise) with a short time width and high amplitude such as ignition noise generated by effects of electronic mirrors or wipers of a vehicle. It is not desirable auditorily that the pulse noise is output from a receiver.

Therefore, a noise eliminating circuit interpolates a generation period of such pulse noise to eliminate the pulse noise from an audio signal acquired by AM detection. Interpolating methods in this case include an interpolating method of retaining the audio signal level before the generation of the pulse noise during the generation period of the pulse noise, an interpolating method of linearly linking the audio signal levels before and after the generation period of the pulse noise during the generation period, etc.

To perform such interpolation, a conventional noise eliminating circuit inputs a noise detection signal detecting the generation of the pulse noise in a front end process (hereinafter, an FE process) and interpolates the generation period of the pulse noise of the audio signal based on the noise detection signal. The noise detection signal is generated by extracting a noise component with an HPF (high-pass filter) from a signal acquired in level detection of an intermediate frequency signal and by comparing the component with a predetermined threshold.

In patent document 1, a method of using detection depending on linear prediction has been proposed which predicts a value of an intermediate frequency signal to be generated from an intermediate frequency signal generated before a predetermined time period to detect the generation of the pulse noise by comparing a difference between a predicted value and an actually generated value with a predetermined threshold.

Patent document 1: Japanese Patent Application Laid-Open Publication No. 2000-278153

When the electric field intensity is weak, more noise is generated due to the weak electric field. Therefore, in the case of the FE process in the weak electric field, the detection accuracy is deteriorated for the noise due to the weak electric field and the pulse noise, and the generation of the pulse noise may be erroneously detected. Therefore, in the case of a noise eliminating circuit that performs the interpolation process based on the pulse noise detection in the FE process, the detection accuracy of the FE process is insufficient in the weak electric field, and even when an audio signal is actually generated, the generation period of the audio signal may be erroneously interpolated as pulse noise.

On the other hand, in the linear prediction, the pulse noise is detected with the use of an intermediate frequency signal with a frequency lowered by frequency conversion in IF units on a plurality of stages to reduce a processing amount, as described later. Therefore, an information amount of the intermediate frequency signal to be detected is reduced as compared to the FE process.

In the linear prediction, input of the intermediate frequency signal with extremely large fluctuations is detected based on fluctuations of the intermediate frequency signal in a predetermined time width. Therefore, in the pulse noise detection using the linear prediction, if a signal with a high modulation degree and a short time width is input after an almost silent level of the intermediate frequency signal is continued, the signal is erroneously detected as pulse noise rather than a sound signal. In the case of the noise eliminating circuit that performs the interpolation process based on the pulse noise detection using the linear prediction, even when an audio signal is actually generated, the generation period of the audio signal may also be erroneously interpolated as pulse noise.

The object of the present invention is to provide a noise eliminating circuit which can eliminate pulse noise accurately regardless of a degree of electric field intensity, by applying a detection signal of the pulse noise selectively depending on the electric field intensity.

### SUMMARY OF THE INVENTION

A major aspect of the present invention provides a noise eliminating circuit comprising a noise elimination processing unit that interpolates a generation period of pulse noise overlapped with a received signal depending on a first detection signal acquired by level detection of an intermediate frequency signal of the received signal, the first detection signal indicating the generation of the pulse noise, wherein the noise eliminating circuit comprises: a predicting unit that predicts a value of the intermediate frequency signal at a predetermined clock time based on an intermediate frequency signal generated a predetermined time earlier than the intermediate frequency signal; a detecting unit that compares a difference between the value of the predicted intermediate frequency signal and the value of the generated intermediate frequency signal, at the predetermined clock time, with a predetermined threshold, to output a second detection signal indicating the generation of the pulse noise; and a noise elimination controlling unit that selectively outputs the first detection signal and the second detection signal as a signal for interpolating the generation period of the pulse noise to the noise elimination processing unit depending on electric field intensity signal acquired based on the intermediate frequency signal.

Other features of the present invention will become more apparent from the contents of the accompanying drawings and the description.

According to the present invention, pulse noise can be eliminated accurately regardless of a degree of the electric field intensity by using the first detection signal and the second detection signal selectively depending on the electric field intensity.

### BRIEF DESCRIPTION OF THE DRAWINGS

For thorough understanding of the present invention and the advantages thereof, the following description should be referenced in conjunction with the accompanying drawings.

FIG. 1 is a block diagram of an AM receiver using a noise eliminating circuit of the present invention.

FIG. 2 is a block diagram of a configuration of an FE detecting unit of the present invention.

FIG. 3 is a block diagram of the noise eliminating circuit of the present invention.

FIG. 4 is a diagram for describing a relationship between electric field intensity and prediction errors.

FIG. 5 shows a relationship between electric field intensity and threshold setting.

FIG. 6 is a flowchart for describing operation of a noise elimination controlling unit of the present invention.

FIG. 7 is a diagram for describing linear interpolation.

### DETAILED DESCRIPTION OF THE INVENTION

From the contents of the description and the accompanying drawings, at least the following details will become apparent.

The following embodiment of the present invention will be described with regard to the case of applying a noise eliminating circuit of the present invention to an AM receiver.

==Configuration of AM Receiver==

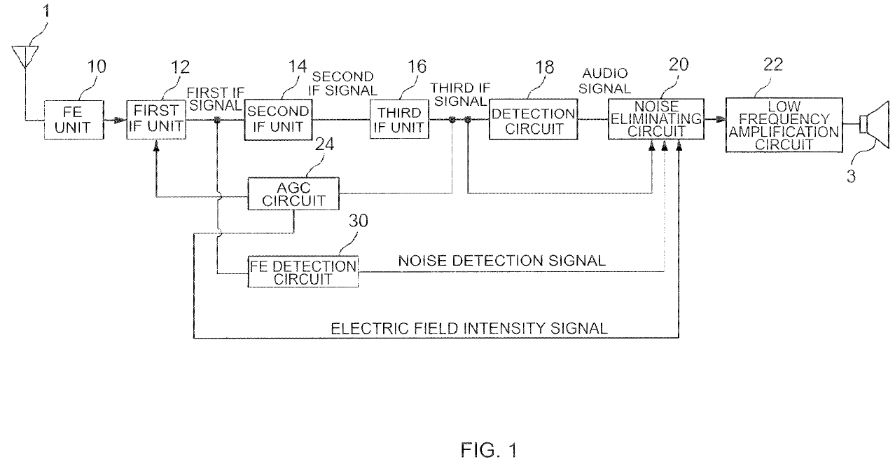

FIG. 1 is a block diagram of an example of a configuration of an AM receiver using a noise eliminating circuit of the present invention. The AM receiver shown in FIG. 1 includes a front end (hereinafter, FE) unit 10, a first intermediate frequency (hereinafter, IF) unit 12, a second IF unit 14, a third IF unit 16, a detection circuit 18, a noise eliminating circuit 20, a low frequency amplifying circuit 22, an AGC circuit 24, and an FE detecting circuit 30.

The FE unit 10 amplifies a received signal received by an antenna 1 to form a signal at a level necessary for the first IF unit 12 on the next stage. The amplification is performed in a limited manner for the target received signal and a frequency band including the received signal so as not to amplify signals other than the target and undesired sound such as noise.

The first IF unit 12 has a function of converting a carrier frequency and includes a local oscillation circuit (not shown) that outputs a local oscillation signal for modulating a frequency of the received signal and a mixing circuit (not shown) that mixes the received signal and the local oscillation signal. The IF signal unit 12 converts the received signal into a predetermined intermediate frequency (e.g., 10.7 MHz). Only a desired signal is extracted by a band-pass filter (BPF: not shown) using the intermediate frequency as a center frequency, is then amplified by an amplifying circuit (not shown), and is output as a first IF signal.

The second IF unit 14 includes a local oscillation circuit (not shown) that outputs a local oscillation signal for modulating a frequency of the first IF signal and a mixing circuit (not shown) that mixes the first IF signal and the local oscillation signal. The second IF unit 14 converts the first IF signal into a predetermined intermediate frequency (e.g., 450 kHz). Only a desired signal is extracted by a band-pass filter (BPF: not shown) using the intermediate frequency as a center frequency, is then amplified by an amplifying circuit (not shown), and is output as a second IF signal.

The third IF unit 16 includes a local oscillation circuit (not shown) that outputs a local oscillation signal for modulating a frequency of the second IF signal and a mixing circuit (not shown) that mixes the second IF signal and the local oscillation signal. The third IF unit 16 converts the second IF signal into a predetermined intermediate frequency (e.g., 9 kHz). Only a desired signal is extracted by a band-pass filter (BPF: not shown) using the intermediate frequency as a center frequency, is then amplified by an amplifying circuit (not shown), and is output as a third IF signal.

The AGC circuit 24 generates an AGC control voltage (hereinafter, signal-meter signal) proportional to the amplitude of the third IF signal. By feeding back the signal-meter signal to the input of the first IF unit 12, a gain of an amplification rate in the first IF unit 12 is controlled. The AGC circuit 24 outputs to the noise eliminating circuit 20 an electric field intensity signal indicating electric field intensity acquired from the signal-meter signal.

The FE detecting circuit 30 performs level detection of the first IF signal to detect pulse noise and outputs to the noise eliminating circuit 20 a noise detection signal (“first detection signal”) indicating the generation of the pulse noise (FE process). The detection circuit 18 removes a carrier component from the third IF signal to output an audio signal that is an original modulated signal. The noise eliminating circuit 20 interpolates the generation period of the pulse noise in the audio signal to eliminate the pulse noise from the audio signal depending on the third IF signal, the noise detection signal, and the electric field intensity signal. The low frequency amplifying circuit 22 amplifies the audio signal and supplies necessary electric power to a speaker 3.

With regard to the received signal received by the antenna 1 in the AM receiver with the above configuration, after a high frequency band is amplified by the front end unit 10, the local oscillation signals are mixed by the first IF unit 12, the second IF unit 14, and the third IF unit 16 to convert the intermediate frequency. The audio signal is acquired by detecting the third IF signal output from the third IF unit 16 with the detection circuit 18. The noise eliminating circuit 20 eliminates the pulse noise overlapping the acquired audio signal based on the third IF signal, a noise elimination signal, and the electric field intensity signal, is amplified by the low frequency amplifying circuit 22, and is output from the speaker 3.

The AM receiver in the embodiment has a DSP (digital signal processor) configuration that digitalizes and detects IF signals. In the case of the AM receiver with the configuration of FIG. 1, the third IF signal is detected by the detection circuit 18 after the digital processing.

Although the IF unit has a three-stage configuration in the embodiment, the IF unit may be other than three-stage, for example, two-stage. The signal-meter signal may be generated from the first IF signal or may be generated from the second IF signal.

The electric field intensity signal may be acquired from the FE detecting circuit 30.

==Configuration of FE Detecting Circuit 30==

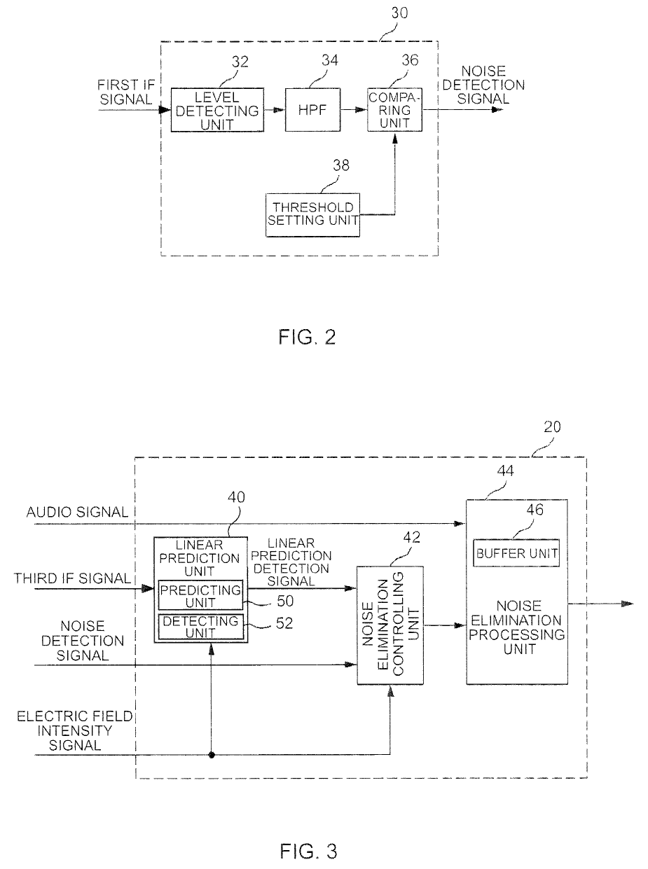

FIG. 2 is a block diagram of an example of a configuration of the FE detecting circuit 30 of the present invention.

The FE detecting circuit 30 includes a level detecting unit 32, a high-pass filter (HPF) 34, a comparing unit 36, and a threshold setting unit 38.

The level detecting unit 32 performs level detection of the input first IF signal (e.g., 10.7 MHz). The HPF 34 allows passage of a noise component in the output of the level detecting unit 32. The threshold setting unit 38 sets in the comparing unit 36 a threshold for determining the generation of the pulse noise. The comparing unit 36 compares a value of the signal passing through the HPF 34 with the threshold set by the threshold setting unit 38. If the signal passing through the HPF 34 is greater than the signal from the threshold setting unit 38, the comparing unit 36 outputs a “HIGH” noise detection signal, for example. On the other hand, if the signal passing through the HPF 34 is less than the signal from the threshold setting unit 38, the comparing unit 36 outputs a “LOW” noise detection signal, for example.

With such a configuration, the FE detecting circuit 30 outputs, for example, the “HIGH” noise detection signal if the pulse noise is detected in the input first IF signal, and outputs the “LOW” noise detection signal if the pulse noise is not detected in the input first IF signal. Therefore, the pulse noise can be interpolated depending on the “HIGH” and “LOW” of the noise detection signals.

==Configuration of Noise Eliminating Circuit 20==

FIG. 3 is a block diagram of a configuration of the noise eliminating circuit 20 of the present invention.

The noise eliminating circuit 20 of the present invention includes a linear prediction unit 40, a noise elimination controlling unit 42, and a noise elimination processing unit 44.

The linear prediction unit 40 detects the generation of the pulse noise based on the third IF signal and the electric field intensity signal and outputs a linear prediction detection signal indicating the generation of the pulse noise. The linear prediction unit 40 includes a predicting unit 50 and a detecting unit 52.

The predicting unit 50 predicts a value of a third IF signal at a predetermined clock time based on a value of a third IF signal generated a predetermined time earlier than the third IF signal.

The detecting unit 52 compares a difference between the value of the third IF signal predicted by the predicting unit 50 and the value of the generated third IF signal with a predetermined threshold to output the linear prediction detection signal (“second detecting signal” of claims 1 to 5 and “detection signal” of claim 6) indicating the generation of the pulse noise.

The noise elimination controlling unit 42 outputs the linear prediction detection signal and the noise detection signal selectively depending on the electric field intensity. The noise elimination processing unit 44 interpolates and outputs the generation period of the pulse noise of the audio signal depending on the output of the noise elimination controlling unit 42. The noise elimination processing unit 44 includes a buffer unit 46 that stores the audio signals input as digital data for a predetermined time period.

In this way, the noise eliminating circuit 20 generates the linear prediction detection signal indicating the generation of the pulse noise in accordance with the linear prediction of the input third IF signal and selectively uses the linear prediction detection signal and the noise detection signal as a signal for interpolating the pulse noise depending on the electric field intensity to interpolates the generation period of the pulse noise of the audio signal. Therefore, the detection accuracy can be improved for the pulse noise of the audio signal input to the noise elimination processing unit 44 and the generation period of the pulse noise can be interpolated accurately.

==Operation of Linear Prediction Unit 40==

The predicting unit 50 of the linear prediction unit 40 predicts a value of the third IF signal with a typical forward linear prediction equation based on a value of the third IF signal generated before a predetermined time. The detecting unit 52 calculates a difference between a value predicted by the predicting unit 50 and a value of the third IF signal actually generated, and compares the difference value with a threshold for detecting the generation of the pulse noise.

If the pulse noise is overlapped with the third IF signal which is input, the difference is greater than the threshold. In this case, the linear prediction unit 40 outputs, for example, the “HIGH” linear prediction detection signal indicating that the pulse noise is detected. On the other hand, if the difference of the third IF signal is less than the threshold, the linear prediction unit 40 outputs, for example, the “LOW” linear prediction detection signal indicating that the pulse noise is not detected.

Therefore, the pulse noise can be interpolated depending on the “HIGH” and “LOW” of the linear prediction detection signals.

The detecting unit 52 of the noise eliminating circuit 20 of the present invention can change the threshold for the comparison with the difference of the third IF signal, depending on the magnitude of the electric field intensity signal.

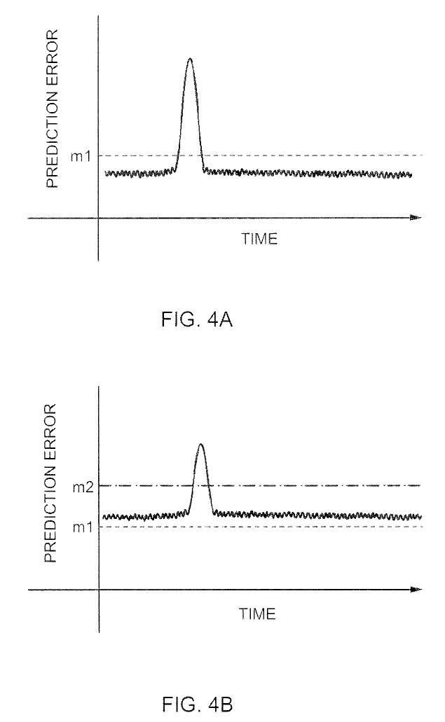

FIG. 4 is a diagram for describing an example of a relationship between electric field intensity and prediction errors. The prediction error is an difference between the value of the third IF signal predicted by the predicting unit 50 from the amplitude value of the third IF signal generated before a predetermined time and the value of the third IF signal actually generated. FIG. 4(a) shows the case of an intense electric field and FIG. 4(b) shows the case of a weak electric field. Reference numerals m1, m2 are thresholds set for performing comparison with the difference of the third IF signal in the detecting unit 52.

As shown in FIG. 4(a), noise components other than the pulse noise included in the audio signal are reduced in the intense electric field. Therefore, the prediction error is reduced in periods other than the generation period of the pulse noise, and the pulse noise can be detected with the threshold m1.

On the other hand, as shown in FIG. 4(b), when the electric field intensity is weakened, the noise components other than the pulse noise are increased in the audio signal. As a result, an overall level of the prediction error is increased and rises higher than the threshold m1 set in FIG. 4(a), for example. In this case, the pulse noise cannot be detected with the threshold m1. If the electric field intensity is weakened in this way, the detecting unit 52 of the noise eliminating circuit 20 of the present invention changes the threshold to the threshold m2 which has a larger value than the threshold m1.

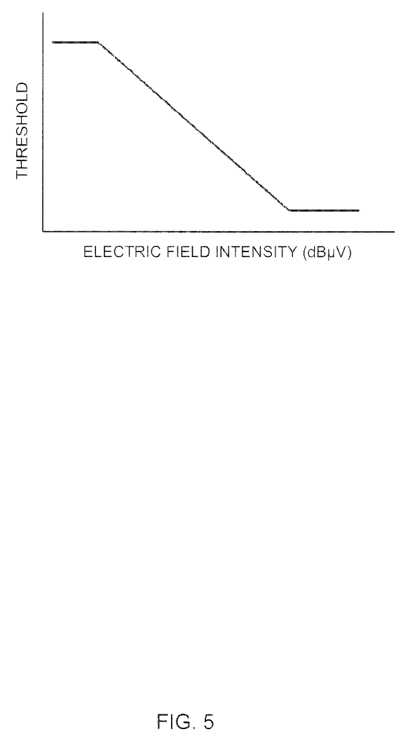

FIG. 5 shows an example of a relationship between the threshold setting in the detecting unit 52 of the noise eliminating circuit 20 of the present invention and the electric field intensity. As shown in FIG. 5, the detecting unit 52 of the noise eliminating circuit 20 of the present invention sets the threshold such that the threshold increases as the electric field intensity weakens when the electric field intensity is within a predetermined range.

By increasing the threshold as the electric field intensity weakens in this way, the pulse noise can be accurately detected in the weak electric field.

In the embodiment according to the present invention, although the threshold of the detecting unit 52 is set as shown in FIG. 5 such that a relation ship of a linear function is generated with the electric field intensity, the threshold may be other than a linear function as long as the threshold is set such that the threshold increases as the electric field intensity weakens.

In the embodiment according to the present invention, although the linear prediction is performed using the third IF signal with a frequency lowered to reduce a processing amount of the linear prediction, the linear prediction may be performed using IF signals other than the third IF signal.

==Operation of Noise Elimination Controlling Unit 42==

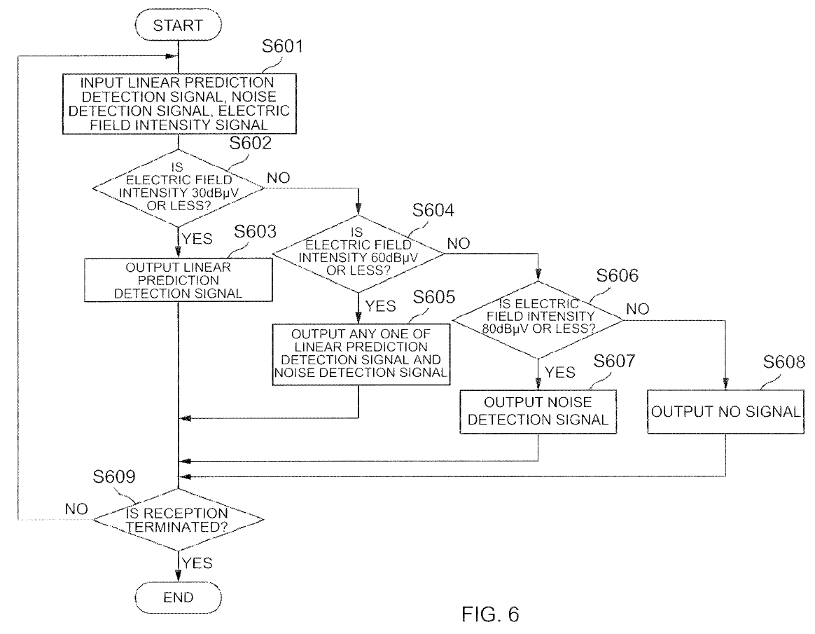

FIG. 6 is a flowchart for describing an example of operation of the noise elimination controlling unit 42 of the noise eliminating circuit 20 of the present invention.

First, the noise elimination controlling unit 42 inputs the linear prediction detection signal, the noise detection signal, and the electric field intensity signal (S601). If the electric field intensity indicated by the input electric field intensity signal is the weak electric field, which is 30 dBμV (“first electric field intensity”) or less (S602: YES), the detection accuracy of the FE detecting circuit 30 is deteriorated and, therefore, the noise elimination controlling unit 42 outputs the linear prediction detection signal as a signal for interpolating the generation period of the pulse noise (S603). The procedure goes to step 609 to determine whether the reception is terminated.

If the electric field intensity indicated by the input electric field intensity signal is greater than 30 dBμV (S602: NO), the procedure goes to step 604 to determine whether the electric field intensity is, e.g., 60 dBμV (“second electric field intensity”) or less. If the electric field intensity is 60 dBμV or less (S604: YES), the pulse noise can be detected by any detecting methods and, therefore, any one of the electric field intensity signal and the noise detection signal is output (S605). The procedure goes to step 609 to determine whether the reception is terminated.

In step 604, if the electric field intensity is greater than 60 dBμV (S604: NO), the procedure goes to step 606 to determine whether the electric field intensity is 80 dBμV (“third electric field intensity”) or less. If the electric field intensity is greater than 60 dBμV and equal to or less than 80 dBμV (S606: YES), the pulse noise detection accuracy is improved by detecting with the FE detecting circuit 30 as compared to the linear detection, which uses a less amount of information, and the noise detection signal is output (S607). The procedure goes to step 609 to determine whether the reception is terminated.

If the electric field intensity indicated by the input electric field intensity signal is greater than, for example, 80 dBμV (S606: NO), the level of noise is low as compared to the level of the audio signal. In this case, to prevent a malfunction due to false detection of the pulse noise, neither the linear prediction detection signal nor the noise detection signal is output (S608). The procedure goes to step 609 to determine whether the reception is terminated. If the reception is not terminated (S609: NO), the procedure goes to step 601 to input the linear prediction detection signal, the noise detection signal, and the electric field intensity signal. If the reception is terminated (S609: YES), the noise reduction control process is terminated.

==Operation of Noise Elimination Processing Unit 44==

The noise elimination processing unit 44 performs the interpolation process of the generation period of the pulse noise of the audio signal, for example, linear interpolation, based on that the output from the noise elimination controlling unit 42 becomes “HIGH”, which indicates the detection of the multipath noise.

In the case of the linear interpolation, the noise elimination processing unit 44 sets an interpolation width for interpolating the generation period of the pulse noise depending on the frequency of the input audio signal. If the audio signal has a low frequency, the interpolation width is increased (e.g., ten samples), and if the audio signal has a high frequency, the interpolation width is reduced (e.g., five samples). In the case of the short interpolation width of five samples, the interpolation process is performed for five samples including a sample corresponding to the detection of the pulse noise, two samples before the sample, and two samples after the sample.

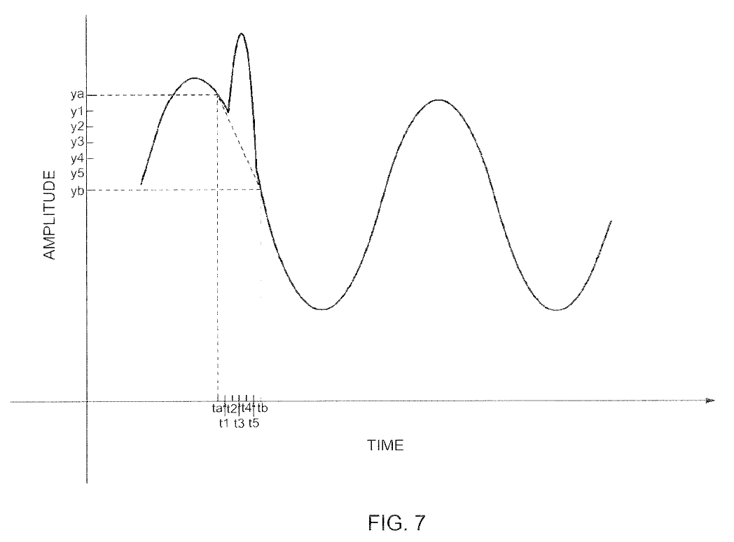

FIG. 7 is a diagram for describing the case of performing the interpolation process of five samples of the audio signal with the linear interpolation.

When the “HIGH” indicating the noise detection is input from the noise elimination controlling unit 42 at time t3 (amplitude y3), the interpolation process is performed for five samples from ta to tb based on amplitude ya at ta, i.e., before three samples, and amplitude yb at tb, i.e., after three samples.

When it is assumed that the signal levels of five samples within the interpolation width ta to tb are y1 to y5, the signal levels can be expressed as follows.

y1=(yb−ya)/6+ya

y2=2×(yb−ya)/6+ya

y3=3×(yb−ya)/6+ya

y4=4×(yb−ya)/6+ya

y5=5×(yb−ya)/6+ya

With y1 to y5, the interpolation process can be performed linearly for the generation period of the pulse noise of the audio signal as shown by a dotted line of FIG. 7 to remove the pulse noise from the audio signal.

Since the noise elimination processing unit 44 includes a buffer unit 46 that stores the audio signals input as digital signals for a predetermined time period, for example, 100 samples each of which is 16-bit data, the noise elimination processing unit 44 can process data before the detection of the pulse noise when the linear interpolation is performed for the audio signal.

By performing a low-pass filter (LPF) process for the audio signal after the interpolation process, discontinuity can be constrained between interpolated portion and non-interpolated portion.

By interpolating the audio signal with the noise elimination processing unit 44 based on the signal output from the noise elimination controlling unit 42, the pulse noise can be eliminated from the audio signal. The interpolation performed by the noise elimination processing unit 44 may be other than the linear interpolation.

As described above, since the noise eliminating circuit 20 according to the present invention selects the signal for interpolating the pulse noise from the linear prediction detection signal and the noise detection signal depending on the electric field intensity, the detection accuracy of the pulse noise can be improved regardless of the magnitude of the electric field intensity. The detection accuracy can be improved by selecting the detection signal suitable for the electric field intensity such that the linear prediction detection signal is selected if the electric field intensity is weak (e.g., 30 dBμV or less) and the noise detection signal is selected if the electric field intensity is intense (e.g., 60 dBμV or more).

If the electric field intensity is that of the intermediate electric field (e.g., 30 to 60 dBμV), the detection accuracy can be improved effectively by using any one of the linear prediction detection signal and the noise detection signal as the signal for interpolating the pulse noise.

If the electric field intensity is considerably intense (e.g., 80 dBμV or more), a malfunction due to the false detection of the pulse noise can be prevented by not outputting both the linear prediction detection signal and the noise detection signal.

By selectively applying the linear prediction detection signal and the noise detection signal depending on the electric field intensity in the AM receiver, the detection accuracy of the pulse noise can be improved regardless of the electric field intensity.

By changing the threshold of the linear prediction depending on the electric field intensity, the linear prediction can be performed accurately even in the case of the weak electric field.

Hereinbefore, the embodiments as exemplified and as preferred at present of the noise eliminating circuit according to the present invention have been described specifically. The concept of the present invention, however, can be changed variously to be performed and applied, and the scope of claims hereinafter can include various modified versions aside from being limited by prior arts.

1. A noise eliminating circuit comprising:
a noise elimination processing unit that interpolates a generation period of pulse noise overlapped with a received signal depending on a first detection signal acquired by level detection of an intermediate frequency signal of the received signal, the first detection signal indicating the generation of the pulse noise;
a predicting unit that predicts a value of the intermediate frequency signal at a predetermined clock time based on an intermediate frequency signal generated a predetermined time earlier than the intermediate frequency signal;
a detecting unit that compares a difference between the value of the predicted intermediate frequency signal and the value of the generated intermediate frequency signal, at the predetermined clock time, with a predetermined threshold, to output a second detection signal indicating the generation of the pulse noise; and
a noise elimination controlling unit that selectively outputs the first detection signal and the second detection signal as a signal for interpolating the generation period of the pulse noise to the noise elimination processing unit depending on electric field intensity signal acquired based on the intermediate frequency signal.

2. The noise eliminating circuit of claim 1, wherein the noise elimination controlling unit outputs the second detection signal as the signal for interpolating the generation period of the pulse noise to the noise elimination processing unit if the electric field intensity signal indicates a predetermined first electric field intensity or less.

3. The noise eliminating circuit of claim 1, wherein the noise elimination controlling unit outputs the first detection signal as the signal for interpolating the generation period of the pulse noise to the noise elimination processing unit if the electric field intensity signal indicates more than a second electric field intensity which is more than the first electric field intensity.

4. The noise eliminating circuit of claim 3, wherein the noise elimination controlling unit outputs any one of the first detection signal and the second detection signal as the signal for interpolating the generation period of the pulse noise to the noise elimination processing unit if the electric field intensity signal indicates: more than the first electric field intensity; and equal to or less than the second electric field intensity.

5. The noise eliminating circuit of claim 3, wherein the noise elimination controlling unit does not output both the first detection signal and the second detection signal if the electric field intensity signal indicates more than a third electric field intensity which is more than the second electric field intensity.

6. The noise eliminating circuit of claim 1, wherein the received signal is an AM received signal.

7. A noise eliminating circuit comprising:
a predicting unit that predicts a value of an intermediate frequency signal at a predetermined clock time based on an intermediate frequency signal generated a predetermined time earlier than the intermediate frequency signal;
a detecting unit that compares a difference between the value of the predicted intermediate frequency signal and the value of the generated intermediate frequency signal, at the predetermined clock time, with a predetermined threshold to output a detection signal indicating the generation of the pulse noise; and
a noise elimination processing unit that interpolates a generation period of pulse noise overlapped with a detection result of a received signal, based on the detection signal, wherein
the detecting unit sets the threshold so as to increase with weakening an electric field intensity signal within a predetermined electric field intensity range, depending on electric field intensity signal acquired based on the intermediate frequency signal.
